(19) United States
(12) Patent Application Publication
(10) Pub. No.: US 2021/0215971 A1
(43) Pub. Date: Jul. 15, 2021

(54) POLARIZER, DISPLAY PANEL AND DISPLAY DEVICE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventors: Yanping LIAO, Beijing (CN); Jiaqing LIU, Beijing (CN); Lihui HAN, Beijing (CN); Jingang LIU, Beijing (CN); Ke DAI, Beijing (CN); Lei GUO, Beijing (CN)

(21) Appl. No.: 16/959,258

(22) PCT Filed: Aug. 29, 2019
(86) PCT No.: PCT/CN2019/103185

§ 371 Date: Jun. 30, 2020

(51) Int. Cl. G02F 1/1335; G02B 5/30

(52) U.S. Cl. CPC G02F 1/133531; G02B 5/305; G02F 1/133504

(57) ABSTRACT

A polarizer includes a first protection layer, a polarizing layer and a second protection layer that are sequentially stacked; and at least one diffusion layer. One diffusion layer is disposed on a side of at least one of the first protection layer and the second protection layer facing away from the polarizing layer, and the diffusion layer is configured to diffuse at least a part of light passing through the diffusion layer.

### CROSS-REFERENCE TO RELATED APPLICATION

This application is a national phase entry under 35 USC 371 of International Patent Application No. PCT/CN2019/103185 filed on Aug. 29, 2019, which is incorporated herein by reference in its entirety.

### TECHNICAL FIELD

The present disclosure relates to the field of display technologies, and in particular, to a polarizer, a display panel and a display device.

### BACKGROUND

A local dimming technology in a liquid crystal display device can control the brightness of backlight in the liquid crystal display device by regions, thereby controlling the display brightness of an image displayed by the liquid crystal display device in different regions, which is beneficial to improving contrast of the liquid crystal display device.

### SUMMARY

In one aspect, a polarizer is provided. The polarizer includes a first protection layer, a polarizing layer and a second protection layer that are sequentially stacked; and at least one diffusion layer. One diffusion layer is disposed at a side of at least one of the first protection layer and the second protection layer facing away from the polarizing layer. The diffusion layer is configured to diffuse at least a part of light passing through the diffusion layer.

In some embodiments, the diffusion layer is a first pressure-sensitive adhesive layer doped with a plurality of particles, and the plurality of particles are configured to diffuse light incident on the plurality of particles.

In some embodiments, the diffusion layer includes a hardening layer, and a plurality of microstructures disposed on a side of the hardening layer facing away from the polarizing layer. The plurality of microstructures is configured to diffuse light incident on the plurality of microstructures.

In some embodiments, the plurality of microstructures include a plurality of particles; or, the hardening layer includes a polyethylene terephthalate layer.

In some embodiments, the plurality of particles include at least one of silica particles, polystyrene resin particles, polymethyl methacrylate particles, or polycarbonate particles.

In some embodiments, the plurality of particles include at least one of spherical particles, cylindrical particles, or pyramid-shaped particles.

In some embodiments, the plurality of microstructures include a plurality of microgrooves.

In some embodiments, the plurality of microgrooves include at least one of hemispherical microgrooves, cylindrical microgrooves, or pyramid-shaped microgrooves.

In some embodiments, the polarizer further includes a second pressure-sensitive adhesive layer. The second pressure-sensitive adhesive layer is disposed on a side of the diffusion layer facing away from the polarizing layer. Or, a diffusion layer is disposed on a side of one of the first protection layer and the second protection layer facing away from the polarizing layer, and the second pressure-sensitive adhesive layer is disposed at a side of the other protection layer without a diffusion layer facing away from the polarizing layer.

In some embodiments, a haze of the polarizer ranges from 5% to 100%.

In some embodiments, the haze of the polarizer ranges from 20% to 60%.

In some embodiments, the first protection layer includes at least one of a triacetyl cellulose layer, a polymethyl methacrylate layer, a cycloolefin polymer layer, or a polyethylene terephthalate layer. The second protection layer includes at least one of a triacetyl cellulose layer, a polymethyl methacrylate layer, a cycloolefin polymer layer, or a polyethylene terephthalate layer. The polarizing layer includes a polyvinyl alcohol layer.

In another aspect, a display module is provided. The display module includes a dimming panel, a first polarizer, a liquid crystal display panel, and a second polarizer that are sequentially stacked. At least one of the first polarizer and the second polarizer is the polarizer described in the above embodiments.

In some embodiments, the display module further includes a jointing adhesive layer. The first polarizer is bonded to the dimming panel through the jointing adhesive layer; or, the first polarizer is bonded to the liquid crystal display panel through the jointing adhesive layer.

In some embodiments, the liquid crystal display panel includes a plurality of sub-pixels. The dimming panel includes a first substrate and a second substrate opposite to each other, and a first liquid crystal layer disposed between the first substrate and the second substrate. The dimming panel has a plurality of dimming regions, and one of the plurality of dimming regions corresponds to at least one sub-pixel.

In some embodiments, the display module further includes a third polarizer disposed on a side of the dimming panel facing away from the liquid crystal display panel.

In another aspect, a display device is provided. The display device includes the display module provided in the above embodiments, and a backlight module disposed at a side of the dimming panel in the display module facing away from the liquid crystal display panel.

### BRIEF DESCRIPTION OF THE DRAWINGS

In order to describe technical solutions in some embodiments of the present disclosure more clearly, the accompanying drawings to be used in the description of embodiments will be introduced briefly. Obviously, the accompanying drawings to be described below are merely some embodiments of the present disclosure, and a person of ordinary skill in the art can obtain other drawings according to these drawings.

FIG. 1 is a schematic diagram showing a structure of a polarizer, in accordance with some embodiments of the present disclosure;

FIG. 2 is a schematic diagram showing a structure of another polarizer, in accordance with some embodiments of the present disclosure;

FIG. 3 is a schematic diagram showing a structure of yet another polarizer, in accordance with some embodiments of the present disclosure;

FIG. 4 is a schematic diagram showing a structure of yet another polarizer, in accordance with some embodiments of the present disclosure;

FIG. 5 is a schematic diagram showing a structure of yet another polarizer, in accordance with some embodiments of the present disclosure;

FIG. 6 is a schematic diagram showing a structure of yet another polarizer, in accordance with some embodiments of the present disclosure;

FIG. 7 is a schematic diagram showing a structure of yet another polarizer, in accordance with some embodiments of the present disclosure;

FIG. 8 is a schematic diagram showing a structure of yet another polarizer, in accordance with some embodiments of the present disclosure;

FIG. 9 is a schematic diagram showing a structure of a microgroove, in accordance with some embodiments of the present disclosure;

FIG. 10 is a schematic diagram showing a structure of another microgroove, in accordance with some embodiments of the present disclosure;

FIG. 11 is a schematic diagram showing a structure of yet another microgroove, in accordance with some embodiments of the present disclosure;

FIG. 12 is a schematic diagram showing a structure of a display module, in accordance with some embodiments of the present disclosure;

FIG. 13 is a schematic diagram showing a structure of another display module, in accordance with some embodiments of the present disclosure;

FIG. 14 is a schematic diagram showing a structure of yet another display module, in accordance with some embodiments of the present disclosure;

FIG. 15 is a schematic diagram showing a distribution of a plurality of dimming regions A of a dimming panel, in accordance with some embodiments of the present disclosure;

FIG. 16 is a schematic diagram showing a distribution of a plurality of sub-pixels of a liquid crystal display panel, in accordance with some embodiments of the present disclosure;

FIG. 17 is a diagram showing a correspondence relationship between dimming regions A and sub-pixels in a display module, in accordance with some embodiments of the present disclosure;

FIG. 18 is a schematic diagram showing a structure of a display device, in accordance with some embodiments of the present disclosure; and

FIG. 19 is a schematic diagram showing a structure of another display device, in accordance with some embodiments of the present disclosure.

### DETAILED DESCRIPTION

Some embodiments of the present disclosure will be described in combination with the accompanying drawings. Obviously, the described embodiments are merely some but not all of the embodiments of the present disclosure. All other embodiments made on the basis of the embodiments of the present disclosure by a person of ordinary skill in the art shall be included in the protection scope of the present disclosure.

Terms “first” and “second” are used for descriptive purposes only, and are not to be construed as indicating or implying the relative importance or implicitly indicating the number of indicated technical features below. Therefore, a feature defined by the term “first” or “second” may include one or more of the features, either explicitly or implicitly. In the description of the embodiments of the present disclosure, term “a/the plurality of” means two or more unless otherwise specified.

In a liquid crystal display device using a local dimming technology, the liquid crystal display device includes a backlight module, a liquid crystal dimming panel and a liquid crystal display panel that are stacked and disposed at a light exit side of the backlight module. The liquid crystal dimming panel has a plurality of dimming regions A. After the light emitted from the backlight module passes through the plurality of dimming regions A of the liquid crystal dimming panel, different display areas of the liquid crystal display panel corresponding to the plurality of dimming regions A can be provided with different backlight brightness respectively.

However, the liquid crystal display panel will receive uneven backlight in the presence of the liquid crystal dimming panel, resulting in rainbow patterns appearing in an image displayed by the liquid crystal display panel, thereby affecting the display effect of the liquid crystal display device.

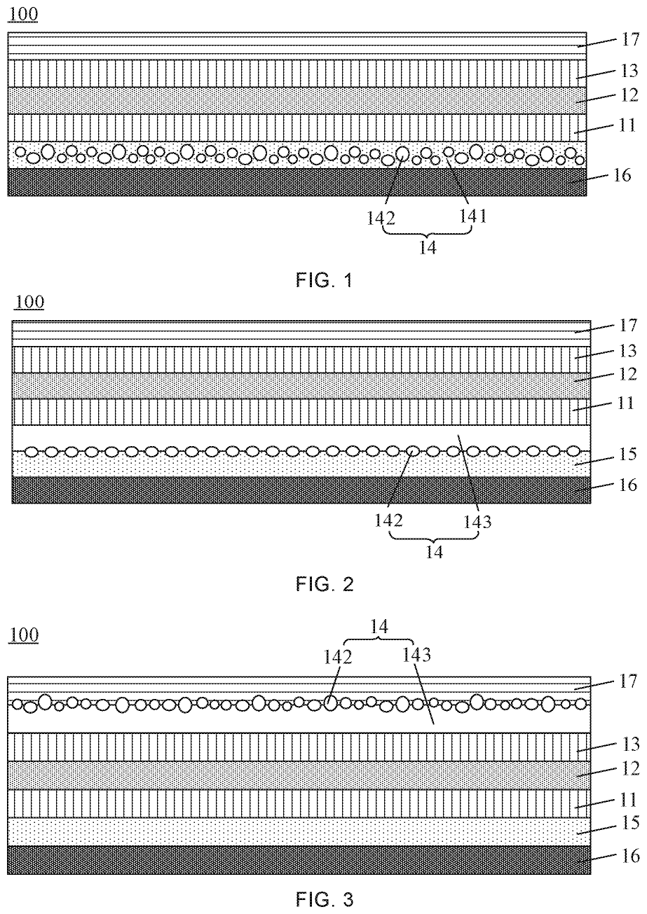

Referring to FIGS. 1 to 8, some embodiments of the present disclosure provide a polarizer 100. The polarizer 100 includes a first protection layer 11, a polarizing layer 12, and a second protection layer 13 that are sequentially stacked; and diffusion layer(s) 14. The diffusion layer 14 is disposed on a side of at least one of the first protection layer 11 and the second protection layer 13 facing away from the polarizing layer 12. The diffusion layer 14 is configured to diffuse at least a part of light passing through the diffusion layer 14.

The polarizing layer 12 has polarization properties, and is configured to turn the non-polarized light passing through itself into the polarized light. In some examples, the polarizing layer 12 is made of polyvinyl alcohol (PVA).

Both the first protection layer 11 and the second protection layer 13 have good light transmittance, good hydrophilic property and good mechanical strength. The first protection layer 11 and the second protection layer 13 are disposed on opposite sides of the polarizing layer 12 respectively, which may protect the polarizing layer 12 from contraction deformation or cracks, and also ensure that the polarizer composed of the first protection layer 11, the polarizing layer 12 and the second protection layer 13 has good light transmittance. In some examples, the first protection layer 11 and the second protection layer 13 are respectively made of at least one of triacetyl cellulose (TAC), polymethyl methacrylate (PMMA) (also referred to acrylic), cycloolefin polymer (COP) or polyethylene terephthalate (PET).

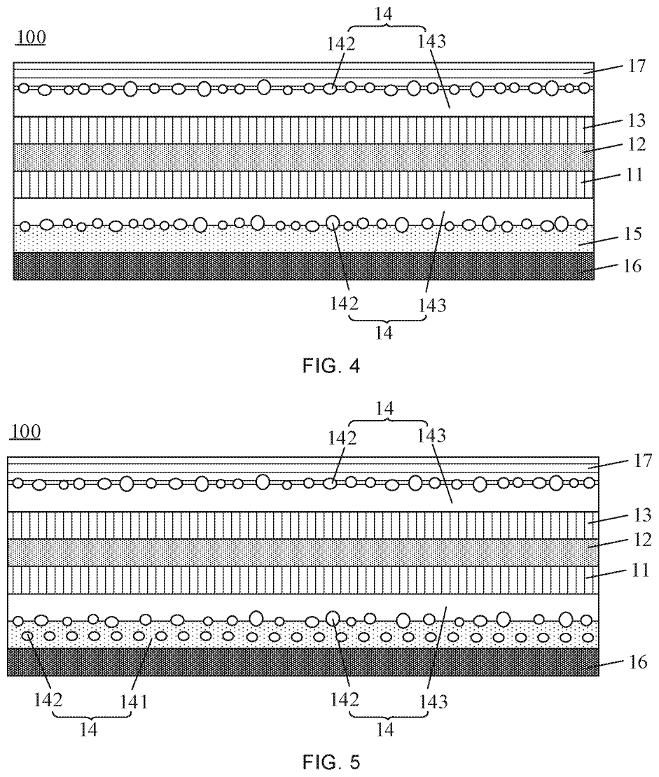

The diffusion layer 14 is disposed on a side of at least one of the first protection layer 11 and the second protection layer 13 facing away from the polarizing layer 12. In some examples, referring to FIGS. 1 and 2, the diffusion layer 14 is disposed on a side of the first protection layer 11 facing away from the polarizing layer 12. In some other examples, referring to FIG. 3, the diffusion layer 14 is disposed on a side of the second protection layer 13 facing away from the polarizing layer 12. In some other examples, referring to FIGS. 4 and 5, the diffusion layers 14 are disposed on the side of the first protection layer 11 facing away from the polarizing layer 12 and on the side of the second protection layer 13 facing away from the polarizing layer 12 respectively.

Of course, arrangement manners of the diffusion layer 14 are not limited to the arrangement manners in the above examples, and the number and position of the diffusion layer 14 may be set according to actual needs.

The diffusion layer 14 is configured to diffuse at least a part of light passing through the diffusion layer 14. That is, the diffusion layer 14 has a certain haze (the haze is the percentage of the intensity of the transmitted light that deviates from the direction of the incident light by more than an angle of 2.5 degrees to the intensity of the total transmitted light). For example, in the process of a beam of incident light passing through the diffusion layer 14, a traveling direction of at least a part of light changes, and the angle between the traveling direction of the part of light and a traveling direction of the incident light is greater than 2.5 degrees, then the percentage of the light intensity of the part of light to the light intensity of the total incident light is the haze of the diffusion layer 14. The light passing through the diffusion layer 14 may have a high uniformity.

Since the diffusion layer 14 has a certain haze, the polarizer 100 has a certain haze. In a case where the polarizer 100 is provided with only one diffusion layer 14, a haze of the polarizer 100 is the haze of the one diffusion layer 14; and in a case where the polarizer 100 is provided with a few diffusion layers 14, the haze of the polarizer 100 is the sum of the haze of each diffusion layer 14 of a few diffusion layers 14.

In some examples, the haze of the polarizer 100 ranges from 5% to 100%, which may effectively improve the uniformity of the light passing through the polarizer 100.

In some other examples, the haze of the polarizer 100 ranges from 20% to 60%, which may not only effectively improve the uniformity of the light passing through the polarizer 100, but also ensure that the polarizer 100 has good light transmittance.

In the polarizer 100 provided by some embodiments of the present disclosure, the polarizer 100 may have a certain haze by providing the diffusion layer 14, and at least a part of light passing through the polarizer 100 is diffused by the polarizer 100. That is, the exit directions of the light passing through the polarizer 100 are various, so that the uniformity of the light passing through the polarizer 100 may be improved.

On this basis, in a case where the polarizer 100 provided by some embodiments described above is applied to a liquid crystal display device using the local dimming technology, the polarizer 100 is usually disposed at a light incident side or a light exit side of a liquid crystal display panel in the liquid crystal display device. In this way, by using the polarizer 100, the uniformity of the light incident on the liquid crystal display panel may be effectively improved, or the uniformity of the light emitted from the liquid crystal display panel may be improved, thereby avoiding rainbow patterns appearing in the image displayed by the liquid crystal display panel, or weakening the rainbow patterns appearing in the image displayed by the liquid crystal display panel, so as to improve the display effect of the liquid crystal display device.

In some embodiments, referring to FIG. 1, the diffusion layer 14 is a first pressure-sensitive adhesive layer 141 doped with a plurality of particles 142, and the plurality of particles 142 are configured to diffuse light incident on the plurality of particles 142. It may be avoided to individually provide a pressure-sensitive adhesive layer or a diffusion layer in the polarizer 100 by using the first pressure-sensitive adhesive layer 141 doped with the plurality of particles 142 as the diffusion layer 14, which may effectively simplify the manufacturing process of the polarizer 100 and effectively reduce a thickness of the polarizer 100.

In some examples, the plurality of particles 142 are evenly dispersed inside the first pressure-sensitive adhesive layer 141. That is, the plurality of particles 142 are not exposed in a surface of the first pressure-sensitive adhesive layer 141 facing the polarizing layer 12 and a surface of the first pressure-sensitive adhesive layer 141 facing away from the polarizing layer 12. In this way, it may prevent the plurality of particles 142 from affecting the bonding strength between the diffusion layer 14 and the first protection layer 11 or between the diffusion layer 14 and the second protection layer 13, or from affecting the bonding strength between the diffusion layer 14 and a device (such as a liquid crystal display panel or a liquid crystal dimming panel) to which the polarizer is bonded.

In addition, the plurality of particles 142 are configured to diffuse light incident on the plurality of particles 142. The light incident on the plurality of particles 142 can be reflected or refracted multiple times under action of the plurality of particles 142, and traveling directions of the light are changed to achieve diffusion of the light. However, light that is not incident on the plurality of particles 142 travels along its original traveling direction.

The particles 142 in some embodiments of the present disclosure refer to geometric objects having a specific shape within a size range, and the size range generally ranges from millimeter to nanometer. The geometric object is not limited to a spherical geometric object. For example, the plurality of particles 142 include at least one of spherical particles, cylindrical particles, or pyramid-shaped particles. In a case where the plurality of particles 142 are a plurality of cylindrical particles or a plurality of pyramid-shaped particles, the arrangement direction of an axis of each of the plurality of particles 142 in the first pressure-sensitive adhesive layer 141 is determined according to actual needs. For example, the axis of each of the plurality of particles 142 is perpendicular or parallel to a surface of the first pressure-sensitive adhesive layer 141 facing away from the polarizing layer 12.

In a case where the plurality of particles 142 are a plurality of spherical particles, please continue to refer to FIG. 1, since the spherical particle have a larger surface area, it is easy to increase a contact area between the spherical particle and light, so that the light incident on the plurality of spherical particles may be better diffused. In this way, it is beneficial to improving the uniformity of the light passing through the diffusion layer 14; moreover, it is beneficial to improving the uniformity of the light passing through the polarizer 100.

Some embodiments of the present disclosure do not limit the material of the plurality of particles 142. For example, the plurality of particles 142 include at least one of silica particles, polystyrene resin particles, polymethyl methacrylate particles, or polycarbonate particles. That is, the plurality of particles 142 are made of at least one of silica, polystyrene resin, polymethyl methacrylate, or polycarbonate.

In other embodiments, referring to FIGS. 2 to 8, the diffusion layer 14 includes a hardening layer 143 and a plurality of microstructures disposed on a side of the hardening layer 143 facing away from the polarizing layer 12. The plurality of microstructures are configured to diffuse the light incident on the plurality of microstructures. In this way, light incident on each microstructure will be reflected or refracted multiple times under action of the microstructure to change traveling directions of the light, thereby achieving a good light diffusion effect. As a result, it is beneficial to improving the uniformity of the light passing through the diffusion layer 14; moreover, it is beneficial to improving the uniformity of the light passing through the polarizer 100.

The diffusion layer 14 is disposed on a side of at least one of the first protection layer 11 and the second protection layer 13 facing away from the polarizing layer 12, which means that the hardening layer 143 is disposed on the side of at least one of the first protection layer 11 and the second protection layer 13 facing away from the polarizing layer 12.

In some examples, the hardening layer 143 generally includes a PET layer, that is, the hardening layer 143 is made of PET. The PET layer has good plasticity and high transparency, which may ensure that the diffusion layer 14 including the PET layer has good light transmittance, thereby reducing or avoiding the loss of light passing through the diffusion layer 14.

The plurality of microstructures described above include a plurality of structures. For example, the plurality of microstructures are a plurality of particles, a plurality of microgrooves, or the like. The plurality of microstructures in the diffusion layer 14 are disposed on a side of the hardening layer 143 facing away from the polarizing layer 12. This design includes: the plurality of microstructures disposed on a surface of the hardening layer 143 facing away from the polarizing layer 12, or the plurality of microstructures disposed in the surface of the hardening layer 143 facing away from the polarizing layer 12.

In addition, the hardening layer 143 is the PET layer, which may ensure that the hardening layer 143 has better plasticity than the first protection layer 11 or the second protection layer 13. As a result, it is convenient for forming the plurality of microstructures on or in a surface of the hardening layer 143. The plurality of microstructures in the diffusion layer 14 are disposed on or in the surface of the hardening layer 143 facing away from the polarizing layer 12, and thereby it is possible to avoid directly forming the plurality of microstructures on or in the surface of the first protection layer 11 or the second protection layer 13 which may cause the corresponding first protection layer 11 or second protection layer 13 to break.

In some examples, referring to FIGS. 2 to 5, the plurality of microstructures include a plurality of particles 142, and the plurality of particles 142 are disposed on the surface of the hardening layer 143 facing away from the polarizing layer 12. In this way, the manufacturing process of the diffusion layer 14 is as follows. First, melting liquid of the hardening layer is coated on the surface of at least one of the first protection layer 11 and the second protection layer 13 facing away from the polarizing layer 12. Then, the plurality of particles 142 are evenly dispersed on the melting liquid of the hardening layer. Thereafter, the melting liquid of the hardening layer on which a plurality of particles 142 are dispersed is solidified to obtain the hardening layer 143, and the plurality of particles 142 are disposed on the surface of the hardening layer 143 facing away from the polarizing layer 12. In this way, the diffusion layer 14 with a stable structure is obtained.

For example, the shape and material of the plurality of particles 142 are the same as the shape and material of the plurality of particles 142 doped in the first pressure-sensitive adhesive layer 141 in some embodiments described above.

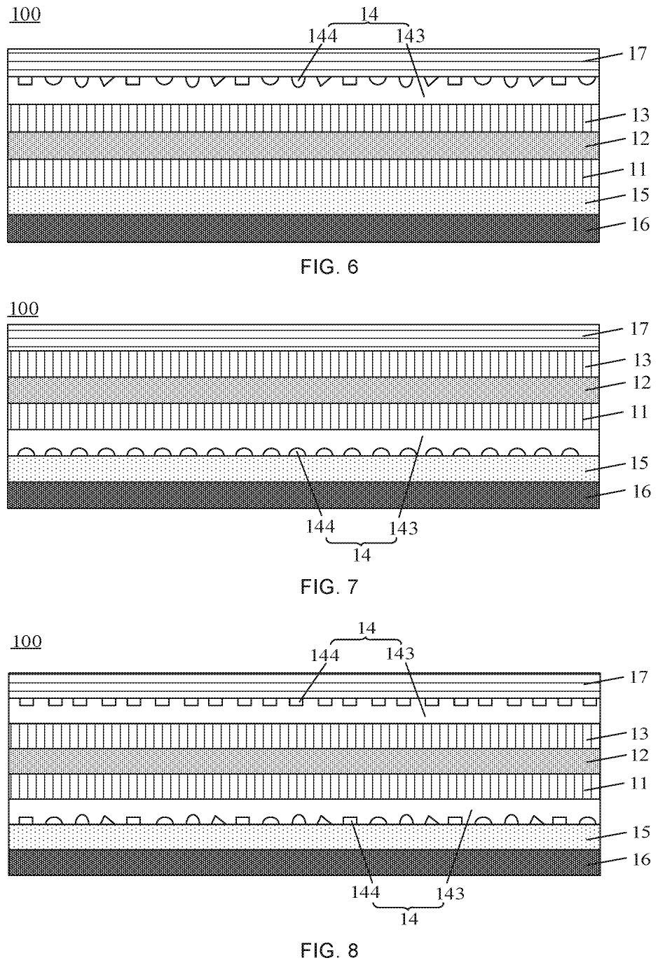

In some other examples, referring to FIGS. 6 to 8, the plurality of microstructures include a plurality of microgrooves 144, and the plurality of microgrooves 144 are disposed in the surface of the hardening layer 143 facing away from the polarizing layer 12. That is, each microgroove 144 is located inside the hardening layer 143. In this way, it is conducive to reducing a thickness of the diffusion layer 14, thereby reducing the thickness of the polarizer 100.

In addition, the manufacturing process of the diffusion layer 14 is as follows. First, a hardening layer 143 is formed on the surface of at least one of the first protection layer 11 and the second protection layer 13 facing away from the polarizing layer 12. Then, a plurality of microgrooves 144 are formed in the surface of the hardening layer 143 facing away from the polarizing layer 12 by etching the surface of the hardening layer 143 facing away from the polarizing layer 12. In this way, the diffusion layer 14 with a stable structure is obtained. Herein, since the hardening layer 143 has certain hardness, a structure with the plurality of microgrooves 144 formed by using the etching manner is stable and not easy to deform.

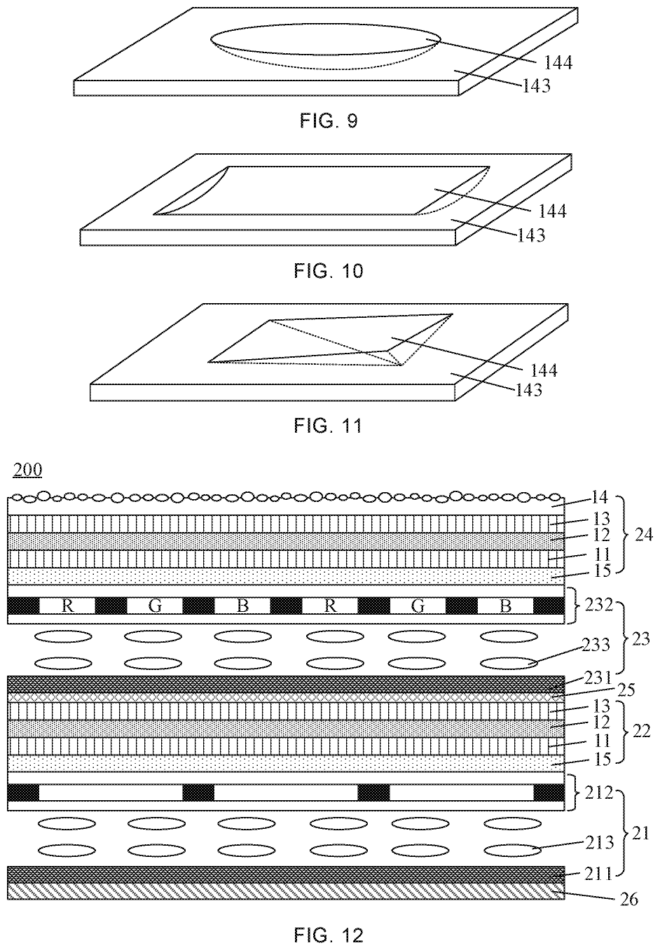

The structure of the plurality of microgrooves 144 has various choices according to actual needs. For example, referring to FIGS. 9 to 11, the plurality of microgrooves 144 include at least one of hemispherical microgrooves, cylindrical microgrooves or pyramid-shaped microgrooves. A structure of the hemispherical microgroove is as shown in FIG. 9, a structure of the cylindrical microgroove is as shown in FIG. 10, and a structure of the pyramid-shaped microgroove is as shown in FIG. 11. Of course, the structures shown in FIGS. 9 to 11 are only for schematically illustrating the structure of the microgroove 144. The structure of the hemispherical microgroove, cylindrical microgroove or pyramid-shaped microgroove is not limited to the structure shown in the drawings, and the arrangement angle of the microgroove in the hardening layer 143 may be set according to the actual situation and the etching process.

In some embodiments, in a case where the diffusion layer 14 in the polarizer 100 is the diffusion layer 14 including the hardening layer 143 and a plurality of microstructures disposed on the surface of the hardening layer 143 facing away from the polarizing layer 12, referring to FIGS. 2 to 4, the polarizer 100 further includes a second pressure-sensitive adhesive layer 15. The second pressure-sensitive adhesive layer 15 is configured to bond the polarizer 100 and the device to which the polarizer is bonded, so as to utilize the polarizer 100 to improve the uniformity of light emitted by the device to which the polarizer is bonded or improve the uniformity of light incident onto the device to which the polarizer is bonded.

There are various choices for the position of the second pressure-sensitive adhesive layer 15 arranged in the polarizer 100. The specific arrangement manner can be determined according to actual needs.

In some examples, the second pressure-sensitive adhesive layer 15 is disposed on the side of the diffusion layer 14 facing away from the polarizing layer 12. For example, referring to FIG. 2, in a case where the diffusion layer 14 is disposed on the side of the first protection layer 11 facing away from the polarizing layer 12, the second pressure-sensitive adhesive layer 15 is disposed on a side of the diffusion layer 14 facing away from the first protection layer 11. In a case where the diffusion layer 14 is disposed on the side of the second protection layer 13 facing away from the polarizing layer 12, the second pressure-sensitive adhesive layer 15 is disposed on a side of the diffusion layer 14 facing away from the second protection layer 13. In a case where one diffusion layer 14 is disposed on the side of the first protection layer 11 facing away from the polarizing layer 12, and one diffusion layer 14 is disposed on the side of the second protection layer 13 facing away from the polarizing layer 12, one second pressure-sensitive adhesive layer 15 is disposed on a side of each diffusion layer 14 of the two diffusion layers 14 facing away from the polarizing layer 12.

In some other examples, a diffusion layer 14 is disposed on a side of one of the first protection layer 11 and the second protection layer 13 facing away from the polarizing layer 12, and a second pressure-sensitive adhesive layer 15 is disposed on a side of the other one without a diffusion layer 14 facing away from the polarizing layer 12. That is, the second pressure-sensitive adhesive layer 15 and the diffusion layer 14 are respectively located at two opposite sides of the polarizing layer 12. For example, in a case where the diffusion layer 14 is disposed at the side of the first protection layer 11 facing away from the polarizing layer 12, the second pressure-sensitive adhesive layer 15 is disposed at the side of the second protection layer 13 facing away from the polarizing layer 12. Referring to FIG. 3, in a case where the diffusion layer 14 is disposed at the side of the second protection layer 13 facing away from the polarizing layer 12, the second pressure-sensitive adhesive layer 15 is disposed on the side of the first protection layer 11 facing away from the polarizing layer 12.

In some embodiments, referring to FIGS. 1 to 2, the polarizer 100 further includes a release film 16. The release film 16 is disposed on a side of the first pressure-sensitive adhesive layer 141 or the second pressure-sensitive adhesive layer 15 facing away from the polarizing layer 12. In this way, the pressure-sensitive adhesive layer covered by the release film 16 may be protected by the release film 16 from being contaminated or damaged.

In some embodiments, referring to FIG. 1, the polarizer 100 further includes an overcoat film 17. The overcoat film 17 is disposed at a side of the polarizer 100 opposite to the release film 16. For example, referring to FIG. 1, the overcoat film 17 is disposed on the side of the second protection layer 13 facing away from the polarizing layer 12, so that the second protection layer 13 covered by the overcoat film 17 can be protected from being damaged.

The polarizer 100 provided by some embodiments of the present disclosure is suitable for various polarizers, such as a transmissive polarizer, a reflective polarizes, a transflective polarizer, and a compensation polarizer.

Some embodiments of the present disclosure provide a display module 200. Referring to FIGS. 12 to 14, the display module 200 includes a dimming panel 21, a first polarizer 22, a liquid crystal panel 23 and a second polarizer 24 that are sequentially stacked. At least one of the first polarizer 22 and the second polarizer 24 is the polarizer 100 provided in some embodiments described above.

The dimming panel 21 includes a first substrate 211 and a second substrate 212 opposite to each other, and a first liquid crystal layer 213 disposed between the first substrate 211 and the second substrate 212. The dimming panel 21 has a plurality of dimming regions A that are arranged in an array. A part of the first substrate 211 in each dimming region A is provided with a dimming drive circuit.

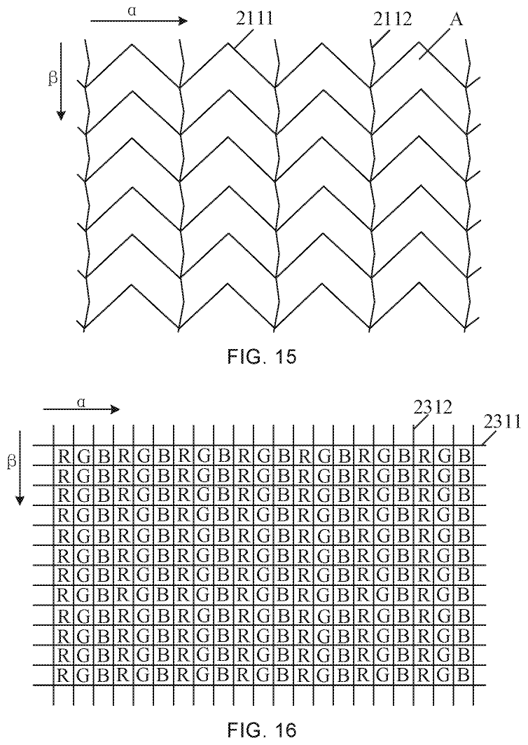

Referring to FIG. 15, the first substrate 211 includes a plurality of first gate lines 2111 extending along a first direction α and a plurality of first data lines 2112 extending along a second direction β. The first direction a is a row direction of the plurality of arranged dimming regions A, and the second direction β is a column direction of the plurality of arranged dimming regions A. Each of the plurality of first gate lines 2111 is electrically connected to dimming drive circuits in at least one row, so as to provide driving signals to the dimming drive circuits in at least one row. Each of the plurality of data lines 2112 is electrically connected to dimming drive circuits in at least one column, so as to provide data signals to the dimming drive circuits in at least one column.

The dimming panel 21 is usually disposed between the liquid crystal display panel 23 and a backlight module corresponding to the liquid crystal display panel 23, so that backlight emitted by the backlight module may enter the liquid crystal display panel 23 through the dimming panel 21. The plurality of first gate lines 2111 and the plurality of first data lines 2112 cooperate with each other to independently control deflection angles of the liquid crystal molecules corresponding to each of the plurality of dimming regions A. In this way, the amount of light passing through each dimming region A may be controlled independently, so that each dimming region A may display different brightness as needed.

Referring to FIGS. 12 to 14, the liquid crystal display panel 23 includes an array substrate 231 and a color filter substrate 232 opposite to each other, and a second liquid crystal layer 233 disposed between the array substrate 231 and the color filter substrate 232. The liquid crystal display panel 23 includes a plurality of sub-pixels that are arranged in an array. A region of the array substrate 231 corresponding to each sub-pixel is provided with a pixel driving circuit.

Referring to FIG. 16, the array substrate 231 includes a plurality of second gate lines 2311 extending along the first direction α and a plurality of second data lines 2312 extending along the second direction β. Each second gate line 2311 is electrically connected to a plurality of pixel driving circuits in at least one row, so as to provide driving signals to the plurality of pixel driving circuits in at least one row. Each second data line 2312 is electrically connected to a plurality of pixel driving circuits in at least one column, so as to provide data signals to the plurality of pixel driving circuits in at least one column. The plurality of second gate lines 2311 and the plurality of second data lines 2312 cooperate with each other, so that the plurality of sub-pixels can display different images as needed.

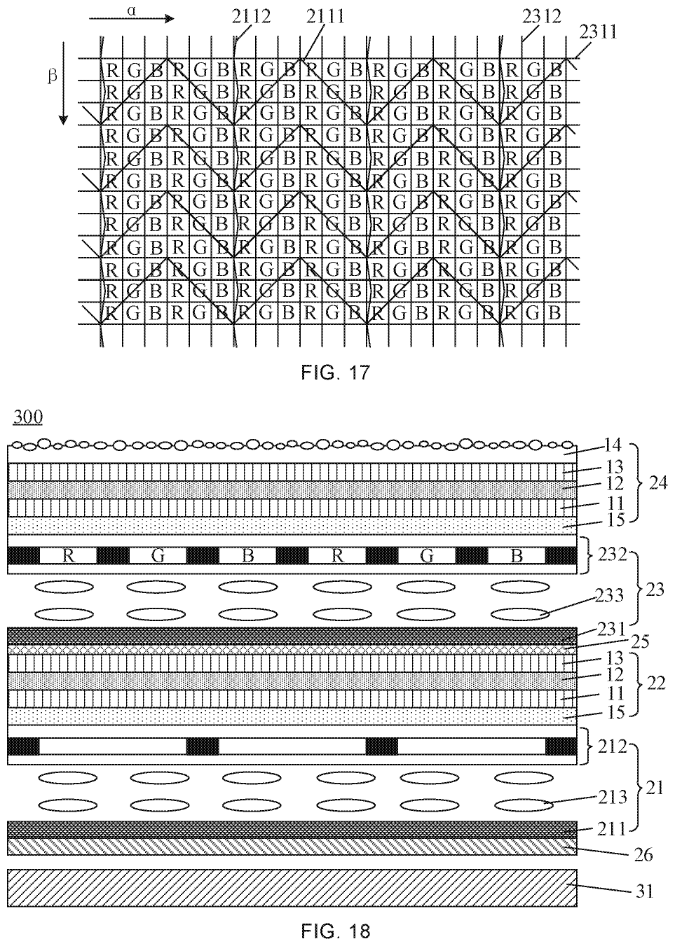

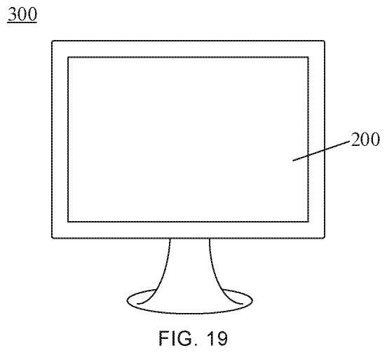

In some examples, referring to FIG. 17, each of the plurality of dimming regions A in the dimming panel 21 corresponds to at least one of the plurality of sub-pixels in the liquid crystal display panel 23. That is, orthographic projection(s) of at least one sub-pixel on the first substrate 211 is within a range of an orthographic projection of each dimming region A on the first substrate 211. Each dimming region A provides backlight to at least one corresponding sub-pixel. In this way, the dimming panel 21 and the liquid crystal display panel 23 cooperate; according to different brightness required by different parts of an image displayed by the liquid crystal display panel 23, brightness of light passing through corresponding dimming regions A of the dimming panel 21 can be adjusted, thereby realizing dynamic dimming of a backlight region. This is beneficial to improving the contrast of the image displayed by the liquid crystal display panel 23, and further beneficial to improving the contrast of the display module 200.

In some examples, at least a part of the plurality of first gate lines 2111 and the plurality of first data lines 2112 in the dimming panel 21 is arranged in polylines (for example, as shown in FIG. 15). In this way, after the dimming panel 21 and the liquid crystal display panel 23 are arranged correspondingly, even if the dimming panel 21 and the liquid crystal display panel 23 are misaligned, the plurality of first gate lines 2111 in the dimming panel 21 and the corresponding second gate lines 2311 in the liquid crystal display panel 23 are not prone to form a grating. Similarly, the plurality of first data lines 2112 in the dimming panel 21 and the corresponding second data lines 2312 in the liquid crystal display panel 23 are not prone to form a grating. In this way, rainbow patterns appearing in the image displayed by the display module 200 may be reduced.

A first polarizer 22 is disposed between the dimming panel 21 and the liquid crystal display panel 23. A second polarizer 24 is disposed at a side of the liquid crystal display panel 23 facing away from the dimming panel 21. At least one of the first polarizer 22 and the second polarizer 24 is the polarizer 100 provided in some embodiments described above.

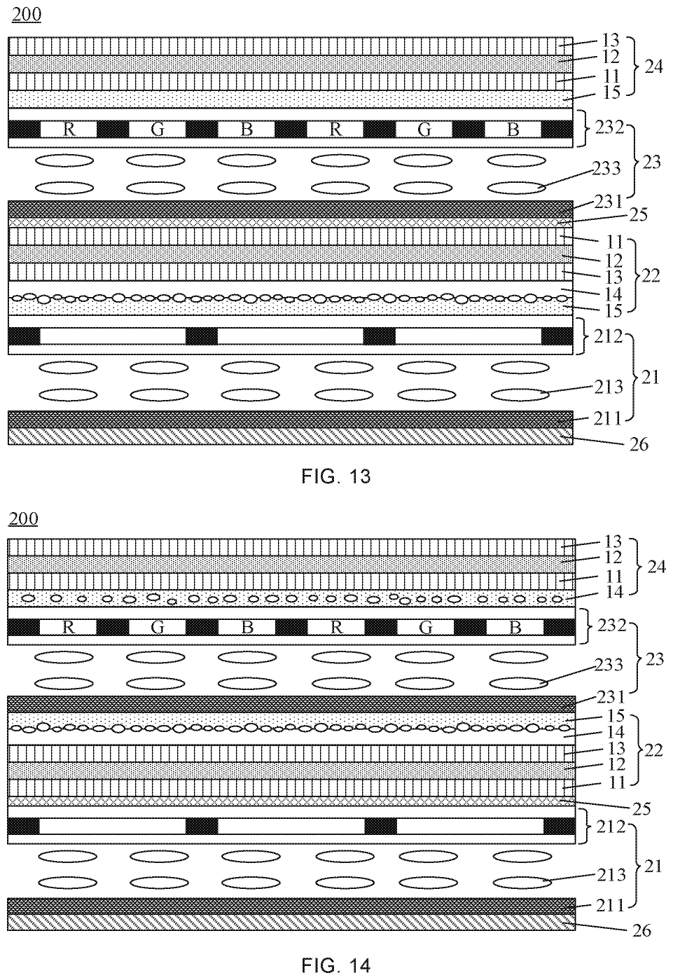

In some examples, referring to FIG. 13, the first polarizer 22 is the polarizer 100 provided in some embodiments described above, so that the first polarizer 22 has a certain haze due to the presence of the diffusion layer 14. Light emitted from the backlight module passes through the dimming panel 21 and the first polarizer 22 in sequence, and then enters the liquid crystal display panel 23. Since a part of light incident on the first polarizer 22 is diffused under action of the diffusion layer 14 in the first polarizer 22, uniformity of light incident on the liquid crystal display panel 23 through the first polarizer 22 is high. It is possible to effectively reduce the rainbow patterns caused by uneven light incident on the liquid crystal display panel 23, which is beneficial to improving the display effect of the display module 200.

In some other examples, referring to FIG. 12, the second polarizer 24 is the polarizer 100 provided in some embodiments described above, so that the second polarizer 24 has a certain haze due to the presence of the diffusion layer 4. Light emitted from the backlight module passes through the dimming panel 21, the first polarizer 22 and the liquid crystal display panel 23 in sequence, and then enters the second polarizer 24. Since a part of light incident on the second polarizer 24 is diffused under action of the diffusion layer 14 in the second polarizer 24, uniformity of light emitted from the second polarizer 24 is improved. It is possible to avoid the interference phenomenon caused by uneven light superposited on each other, thereby reducing the rainbow patterns due to the interference phenomenon caused by uneven light, and effectively improving the display effect of the display module 200.

In some other examples, referring to FIG. 14, both the first polarizer 22 and the second polarizer 24 are the polarizer 100 provided in some embodiments described above. Light emitted from the backlight module passes through the dimming panel 21, the first polarizer 22, the liquid crystal display panel 23 and the second polarizer 24 in sequence. A part of light incident on the first polarizer 22 is diffused under action of the diffusion layer 14 in the first polarizer 22, and uniformity of light incident on the liquid crystal display panel 23 through the first polarizer 22 is high. A part of light incident on the second polarizer 24 is diffused under action of the diffusion layer 14 in the second polarizer 24, and uniformity of light emitted from the second polarizer 24 is improved. This may further reduce the rainbow patterns caused by uneven light, and further improve the display effect of the display module 200.

In the display module 200 provided by some embodiments of the present disclosure, at least one of the first polarizer 22 and the second polarizer 24 is the polarizer 100 in some embodiments described above, light incident on the liquid crystal display panel 23 and/or light emitted from the second polarizer 24 is more uniform. As a result, the interference phenomenon of light may be avoided or reduced, thereby avoiding or reducing the rainbow patterns formed due to the interference of light, and improving the display effect of the display module 200.

In some embodiments, the first polarizer 22 and the second polarizer 24 each include pressure-sensitive adhesive layer(s) (including the first pressure-sensitive adhesive layer 141 and the second pressure-sensitive adhesive layer 15). In a process of assembling the dimming panel 21, the first polarizer 22, the liquid crystal display panel 23 and the second polarizer 24, they are assembled through a bonding manner. That is, the first polarizer 22 is bonded to a side of the dimming panel 21 proximate to the liquid crystal display panel 23 through the pressure-sensitive adhesive layer in the first polarizer 22 or the first polarizer 22 is bonded to a side of the liquid crystal display panel 23 proximate to the dimming panel 21 through the pressure-sensitive adhesive layer in the first polarizer 22, and the second polarizer 24 is bonded to a side of the liquid crystal display panel 23 away from the dimming panel 21 through the pressure-sensitive adhesive layer in the second polarizer 24. In this way, the assembling process may be effectively simplified and the efficiency of assembly may be improved.

Based on that the first polarizer 22 is bonded to one of the dimming panel 21 or the liquid crystal display panel 23, in some embodiments, the display module 200 further includes a jointing adhesive layer 25. In this case, the first polarizer 22 can be bonded to one of dimming panel 21 or the liquid crystal display panel 23 that is to be bonded through the jointing adhesive layer 25.

In some examples, referring to FIG. 13, the first polarizer 22 is bonded to the dimming panel 21 through the jointing adhesive layer 25. That is, the jointing adhesive layer 25 is disposed between the first polarizer 22 and the dimming panel 21. A side of the jointing adhesive layer 25 is bonded to the dimming panel 21, and the opposite side thereof is bonded to the first polarizer 22. The first polarizer 22 is bonded to the liquid crystal display panel 23 through the pressure-sensitive adhesive layer in the first polarizer 22. In this way, the dimming panel 21 and the liquid crystal display panel 23 can be fixed.

In some other examples, referring to FIG. 12, the first polarizer 22 is bonded to the liquid crystal display panel 23 through the jointing adhesive layer 25. That is, the jointing adhesive layer 25 is disposed between the first polarizer 22 and the liquid crystal display panel 23. A side of the jointing adhesive layer 25 is bonded to the liquid crystal display panel 23, and the opposite side thereof is bonded to the first polarizer 22. The first polarizer 22 is bonded to the dimming panel 21 through the pressure-sensitive adhesive layer in the first polarizer 22. In this way, the dimming panel 21 and the liquid crystal display panel 23 can be fixed.

In some embodiments, the display module 200 further includes a third polarizer 26. Referring to FIGS. 12 and 13, the third polarizer 26 is disposed at a side of the dimming panel 21 facing away from the liquid crystal display panel 23. It may be ensured that backlight incident on the dimming panel 21 is polarized light by providing the third polarizer 26. The third polarizer 16 cooperates with the first polarizer 22 and the second polarizer 24, and the display module 200 realize displaying images.

In some examples, the third polarizer 26 includes a second pressure-sensitive adhesive layer configured to be bonded to a side of the dimming panel 21 facing away from the liquid crystal display panel 23; and a first protection layer, a polarizing layer and a second protection layer that are sequentially stacked on the second pressure-sensitive adhesive layer. Of course, a structure of the third polarizer 26 is not limited to the structure provided in the above examples.

Some embodiments of the present disclosure provide a display device 300. Referring to FIG. 17, the display device 300 includes the display module 200 provided in some embodiments described above, and a backlight module 31 disposed at a side of the dimming panel in the display module facing away from the liquid crystal display panel. The display module 200 in the display device 300 has the same advantages as the display module 200 in some embodiments described above, which is not described herein again.

In some examples, the backlight module 31 includes an edge-lit backlight module or a back-lit backlight module.

In some embodiments, the display device 300 is a product or a component having a display function, such as a mobile phone, a tablet computer, a notebook computer, a display, a television, a digital photo frame, or a navigator.

In the description of the above embodiments, specific features, structures, materials or characteristics may be combined in a proper manner in any one or more embodiments or examples.

The forgoing descriptions are merely specific implementation manners of the present disclosure, but the protection scope of the present disclosure is not limited thereto. A person skilled in the art could readily conceive of changes or replacements within the technical scope of the present disclosure, which shall be included in the protection scope of the present disclosure. Therefore, the protection scope of the present disclosure shall be subject to the protection scope of the claims.

1. A polarizer, comprising:
a first protection layer, a polarizing layer and a second protection layer that are sequentially stacked; and
at least one diffusion layer, wherein one diffusion layer is disposed on a side of at least one of the first protection layer and the second protection layer facing away from the polarizing layer, and the diffusion layer is configured to diffuse at least a part of light passing through the diffusion layer.

2. The polarizer according to claim 1, wherein the diffusion layer is a first pressure-sensitive adhesive layer doped with a plurality of particles, and the plurality of particles are configured to diffuse light incident on the plurality of particles.

3. The polarizer according to claim 1, wherein the diffusion layer includes:
a hardening layer, and
a plurality of microstructures disposed on a side of the hardening layer facing away from the polarizing layer, wherein the plurality of microstructures is configured to diffuse light incident on the plurality of microstructures.

4. The polarizer according to claim 3, wherein the plurality of microstructures include a plurality of particles; or, the hardening layer includes a polyethylene terephthalate layer.

5. The polarizer according to claim 2, wherein the plurality of particles include at least one of silica particles, polystyrene resin particles, polymethyl methacrylate particles, or polycarbonate particles.

6. The polarizer according to claim 2, wherein the plurality of particles include at least one of spherical particles, cylindrical particles, or pyramid-shaped particles.

7. The polarizer according to claim 3, wherein the plurality of microstructures include a plurality of microgrooves.

8. The polarizer according to claim 7, wherein the plurality of microgrooves include at least one of hemispherical microgrooves, cylindrical microgrooves, or pyramid-shaped microgrooves.

9. The polarizer according to claim 3, further comprising a second pressure-sensitive adhesive layer; wherein
the second pressure-sensitive adhesive layer is disposed on a side of the diffusion layer facing away from the polarizing layer; or
a diffusion layer is disposed on a side of one of the first protection layer and the second protection layer facing away from the polarizing layer, and the second pressure-sensitive adhesive layer is disposed at a side of the other protection layer without a diffusion layer facing away from the polarizing layer.

10. The polarizer according to claim 1, wherein a haze of the polarizer ranges from 5% to 100%.

11. The polarizer according to claim 10, wherein the haze of the polarizer ranges from 20% to 60%.

12. The polarizer according to claim 1, wherein
the first protection layer includes at least one of a triacetyl cellulose layer, a polymethyl methacrylate layer, a cycloolefin polymer layer, or a polyethylene terephthalate layer;
the second protection layer includes at least one of a triacetyl cellulose layer, a polymethyl methacrylate layer, a cycloolefin polymer layer, or a polyethylene terephthalate layer; and
the polarizing layer includes a polyvinyl alcohol layer.

13. A display module, comprising: a dimming panel, a first polarizer, a liquid crystal display panel and a second polarizer that are sequentially stacked; wherein at least one of the first polarizer and the second polarizer is the polarizer according to claim 1.

14. The display module according to claim 13, further comprising: a jointing adhesive layer; wherein
the first polarizer is bonded to the dimming panel through the jointing adhesive layer; or
the first polarizer is bonded to the liquid crystal display panel through the jointing adhesive layer.

15. The display module according to claim 13, wherein
the liquid crystal display panel includes a plurality of sub-pixels;
the dimming panel includes a first substrate and a second substrate opposite to each other, and a first liquid crystal layer disposed between the first substrate and the second substrate; and the dimming panel has a plurality of dimming regions, and one of the plurality of dimming regions corresponds to at least one sub-pixel.

16. The display module according to claim 13, further comprising: a third polarizer disposed on a side of the dimming panel facing away from the liquid crystal display panel.

17. A display device, comprising:
the display module according to claim 13, and
a backlight module disposed at a side of the dimming panel in the display module facing away from the liquid crystal display panel.

18. The polarizer according to claim 4, wherein the plurality of particles include at least one of silica particles, polystyrene resin particles, polymethyl methacrylate particles, or polycarbonate particles.

19. The polarizer according to claim 4, wherein the plurality of particles include at least one of spherical particles, cylindrical particles, or pyramid-shaped particles.
